(19) United States
(12) Patent Application Publication
(10) Pub. No.: US 2024/0286721 A1
(43) Pub. Date: Aug. 29, 2024

(54) WATERCRAFT RINSE SYSTEM

(71) Applicant: Rich Kroeze, Cape Coral, FL (US)

(72) Inventor: Richard Kroeze, Cape Coral, FL (US)

(21) Appl. No.: 18/113,335

(22) Filed: Feb. 23, 2023

(51) Int. Cl. B63B 59/06; G01F 13/00

(52) U.S. Cl. CPC B63B 59/06; G01F 13/00

(57) ABSTRACT

Systems and methods for rinsing contaminants from exposed portions of a watercraft.

### BACKGROUND OF THE INVENTION

### 1. Field of the Invention

The present invention pertains to system and methods for removing contaminates from exposed surfaces of a watercraft, e.g., motorboat, sailboat, Jet Ski.

### 2. Background of the Invention

Typically, removing contaminates from exposed surfaces of a watercraft entails a person using a garden hose and brush to scrub the exposed surfaces. With an average cleaning time of one hour using 135-255 gallons of water (a typical garden hose having a flow rate between 9 and 17 gallons per minute and being used for 15 minutes), this method wastes a person's time and consumes many gallons of water. Additionally, this method is not practical in instances where the watercraft is stored on a boat lift.

Another method entails raising the watercraft out of the body of water to inhibit the growth of contaminants such as seaweed, moss, algae, and barnacles. While removing the watercraft from the body of water greatly reduces the growth, it does not remove contaminants from the surfaces of the watercraft such as salt when the watercraft is used in salt water body.

What is needed in the art is a watercraft rinse system that removes contaminates while greatly reducing the amount of time and water consumed during the removal process.

### SUMMARY OF THE INVENTION

In one exemplary embodiment formed in accordance with the present disclosure, there is provided a watercraft rinsing system. The system including a plurality of conduits being arranged in a configuration whereby a portion of the plurality of conduits forms a first layer, a second layer and a third layer. Each layer is arranged substantially parallel to a ground surface. A plurality of fresh water outlets is arranged along the plurality of conduits. A plurality of fasteners are provided for mounting the plurality of conduits to a mounting surface.

The system further includes a controller configured for operating the system and a water inlet being configured for connection with a water source. The system may further include a pressure booster having an inlet and outlet. The pressure booster inlet may be connected with the water inlet. The system may also include a splitter having an inlet and three outlets where the splitter inlet may be connected with the outlet from the pressure booster. The system may also include a plurality of valves each having an inlet and outlet where each of the plurality of valve inlets may be connected to each of the splitter outlets.

The controller may be operably connected to each of the dedicated flow sensors and configured to shut off the flow of water to any conduit once said conduit has received one hundred gallons of water.

An advantage of the present invention is the reduction on manual labor to rinse a watercraft off.

Another advantage of the present invention is the reduction of water consumed to rinse a watercraft off.

### BRIEF DESCRIPTION OF THE DRAWINGS

For the purpose of illustration, there are shown in the drawings certain embodiments of the present invention. It should be understood, however, that the invention is not limited to the precise arrangements, dimensions, and instruments shown. Like numerals indicate like elements throughout the drawings. In the drawings:

FIG. 1 illustrates an embodiment of a watercraft rinse system according to the invention;

FIG. 2 illustrates another embodiment of a watercraft rinse system according to the invention;

FIG. 3 illustrates another embodiment of a watercraft rinse system according to the invention;

FIG. 4a illustrates a side view of an embodiment of a watercraft rinse system according to the invention;

FIG. 4b illustrates a side view of an embodiment of a watercraft rinse system according to the invention;

FIG. 5 illustrates a portion of an embodiment of a watercraft rinse system according to the invention;

FIG. 6 illustrates a method for rinsing a watercraft;

FIG. 7 illustrates another method for rinsing a watercraft;

FIG. 8 illustrates another method for rinsing a watercraft;

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

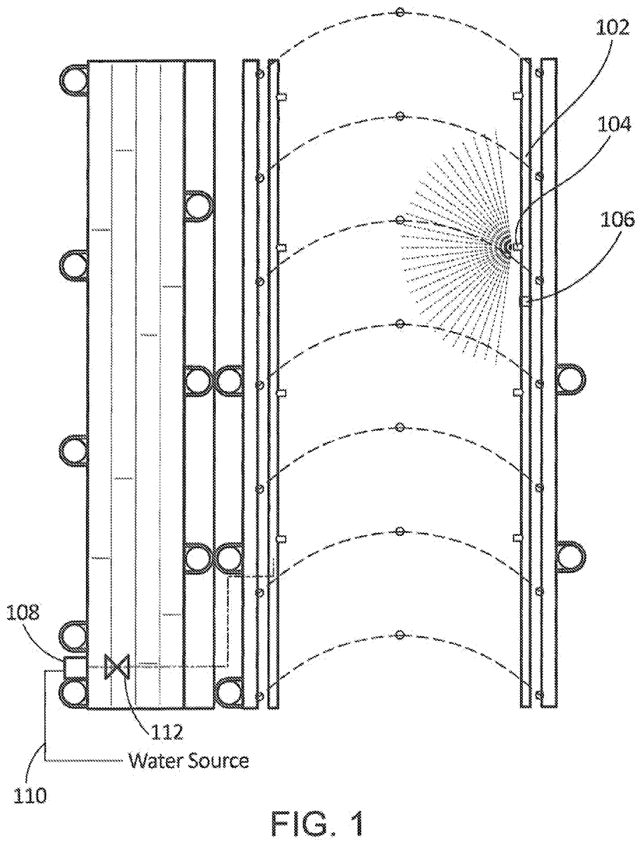

Referring now to the drawings, and more particularly to FIG. 1 there is shown an exemplary embodiment of a watercraft rinse system 100. The watercraft rinse system 100 being generally comprised of a conduit 102 suitable for carrying water, such as PVC, PEX, ABS, galvanized steel and other similar conduit 102. The watercraft rinse system 100 further including a plurality of fresh water outlets 104, for instance, nozzles and sprayers, being arranged along the conduit 102. The watercraft rinse system 100 may further include a plurality of conduit fasteners 106 being used to mount or affix the conduit 102 to an existing structure such as a watercraft lift system.

The watercraft rinse system 100 may be configured for various designs of systems used to raise a watercraft out of a body of water, for instance, a watercraft lift having a fixed portion and a movable portion. Mounting of the conduit 102 may be accomplished by mounting or affixing on sufficiently horizontal portions of a watercraft lift system in the lateral and/or longitudinal directions. It should also be understood that the conduit 102 may be mounted or affixed on sufficiently vertical structures of the watercraft lift system and may arranged such that it is linear or curved. It should also be noted that the conduit 102 may be mounted or affixed on a fixed and/or movable portion of the watercraft lift system.

The watercraft rinse system 100 may further include a controller 108 being configured to provide fresh water from a fresh water source 110 to the plurality of fresh water outlets 104 through the conduit 102. The fresh water source 110 may be any water source used to provide water to a household, for instance but limited to, from a city, a well, or a cistern. The fresh water source 110 may also be processed prior to being used by the watercraft rinse system 100. The processing may include but is not limited to, water softening, water purification, and deionization.

The controller 108 may be configured to provide fresh water to all of fresh water outlets 104 simultaneously or selectively via at least one valve 112. If operably connected to the controller 108, the configuration may be preset in the controller 108, selectable from a user input, or automated through the user of sensors connected to the controller 108. Additionally, the at least one valve 112 may be manually operated.

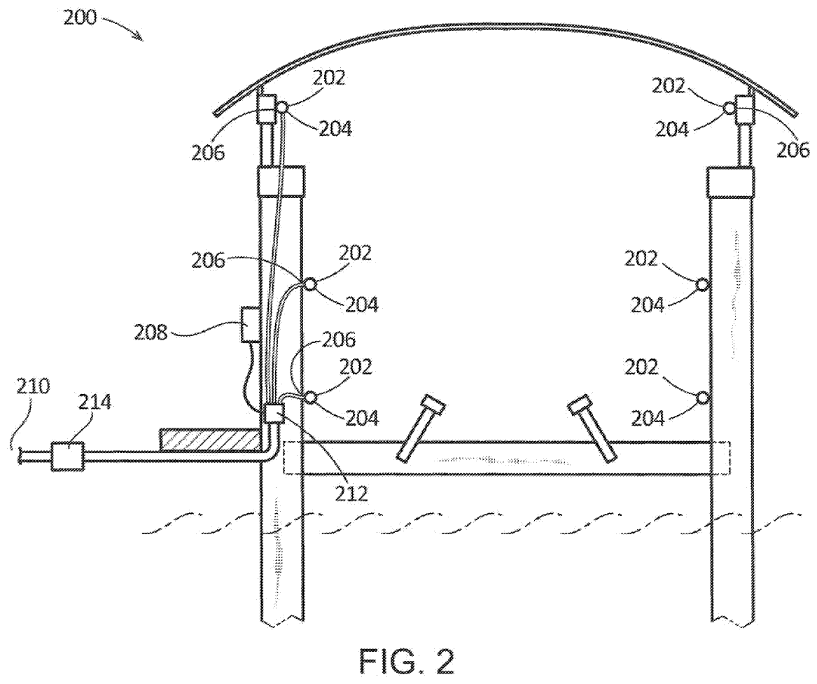

Now referring to FIG. 2, there is shown an exemplary watercraft rinse system 200 being mounted on a boat lift system. The watercraft rinse system 200 being generally comprised of a conduit 202 suitable for carrying water, such as PVC, PEX, ABS, galvanized steel and other similar conduit 202. The conduit 202 may be arranged in three tiers or levels. In general, the tiers may include a top conduit 216, a mid-conduit 218, and a lower conduit 220. While three tiers or levels have been described, it should be noted that the watercraft rinse system 200 may include as many tiers or levels as needed for a particular watercraft, for instance, the watercraft rinse system may include intermediate tiers, overhead tiers, or bottom tiers. The tiers may also run just the length of the watercraft or may include a connecting section between the two lengthwise tiers forming a front section. The conduit 202 may also be arranged such that each section is sufficiently linear or curved with each watercraft rinse system 200 having all sufficiently linear, all curved, or a combination of sufficiently linear and curved conduit 202.

The watercraft rinse system 200 further including a plurality of fresh water outlets 204, for instance, nozzles and sprayers, being arranged along the conduit 202. While the system 200 has been described with nozzles and sprayers, the system 200 may use any other types of fresh water outlets or the conduit 202 may be arranged with a simple opening of any shape. The top conduit 216, the mid-conduit 218, and the lower conduit 220 may include the same or different number of fresh water outlets 204 dependent upon the type of watercraft.

The watercraft rinse system 200 may further include a plurality of conduit fasteners 206 being used to mount or affix the conduit 202 to an existing structure such as a watercraft lift system. Mounting of the conduit 202 may be accomplished by mounting or affixing on sufficiently horizontal portions of a watercraft lift system in the lateral and/or longitudinal directions. It should also be understood that the conduit 202 may be mounted or affixed on sufficiently vertical structures of the watercraft lift system and may arranged such that it is linear or curved. It should also be noted that the conduit 202 may be mounted or affixed on a fixed and/or movable portion of the watercraft lift system.

The watercraft rinse system 200 may further include a controller 208 being configured to provide fresh water from a fresh water source 210 to the plurality of fresh water outlets 204 through the conduit 202. The controller 208 may be configured to provide fresh water to all of fresh water outlets 204 or selectively via at least one valve 212. The at least one valve 212 may be manually operated or may be operably connected to the controller 208. In instances where the pressure of the fresh water source 210 is low, for instance, less than 40 psi, a pressure booster 214 may be added to increase the pressure to 52 psi to 70 psi for optimum performance of the watercraft rinse system 200.

The pressure booster 214 may be configured to operate continuously during operation of the watercraft rinse system 200 or it may be configured to operate as needed. For instance, a pressure sensor—operably connected to the controller 208—may be located between the fresh water source 210 and the pressure booster 214 to detect when the water pressure drops below 30 psi. In instances where the water pressure drops below 30 psi, the controller 208 will cause the pressure booster 214 to operate and continue operating until the pressure of the fresh water source 210 exceeds 52-75 psi. The controller 208 may also cause the pressure booster 214 to operate when all of the fresh water outlets 204 are opened or in instances where a water pressure of 52-75 psi is desired to remove excessive contamination from the watercraft.

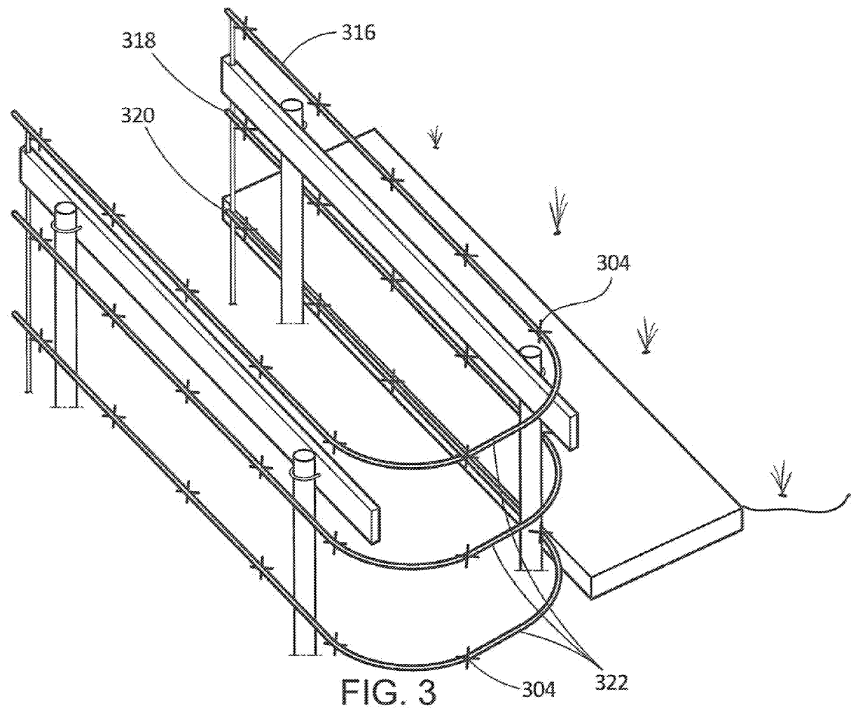

Now referring to FIG. 3, there is shown an exemplary embodiment of the invention having three tiers—a top conduit 316, a mid-level conduit 318, and a lower conduit 320. This embodiment of the invention, includes a front section 322 being formed between each tier. The front section 322 is further supplied with a plurality of fresh water outlets 304 for removing contaminates from the bow of a watercraft, when the watercraft enters the boat lift in a forward motion. This configuration is an exemplary example of a configuration having conduit sections that are sufficiently linear and curved.

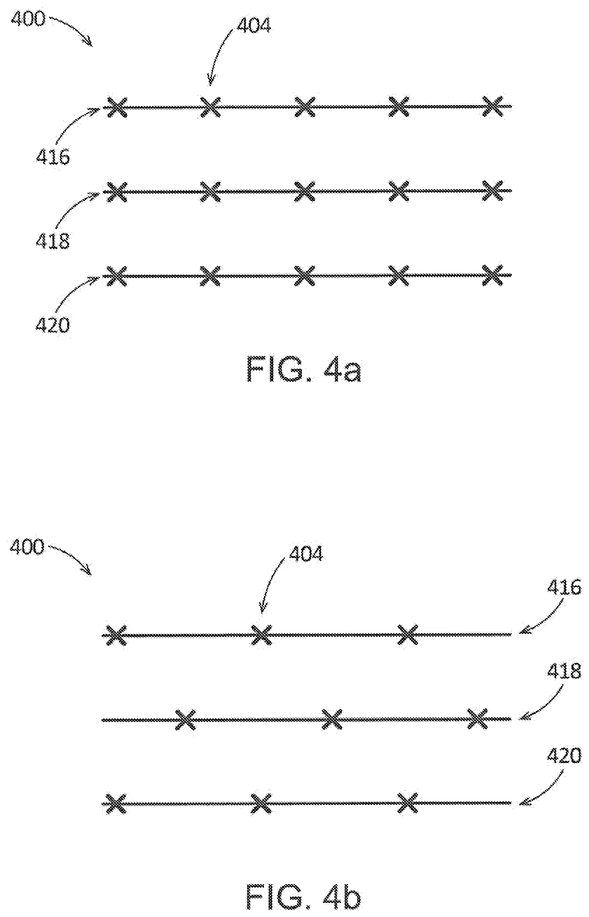

FIGS. 4a and 4b show side views of two configurations of a watercraft rinse system 400. In FIG. 4a, a plurality of fresh water outlets 404 are arranged such that the plurality of fresh water outlets 404 are stacked sufficiently vertical between the top conduit 416, the mid-level conduit 418, and the lower conduit 420.

In FIG. 4b, a plurality of fresh water outlets 404 are arranged such that the plurality of fresh water outlets 404 are staggered between the top conduit 416, the mid-level conduit 418, and the lower conduit 420. It is to be understood that in either configuration, the plurality of fresh water outlets 404 extend along both sides of the watercraft rinse system 400 and may extend along a front section between each tier.

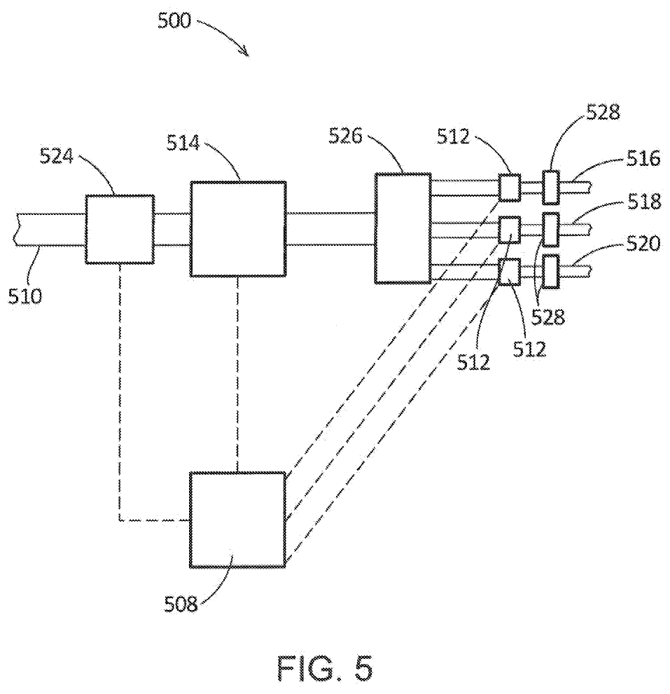

Now referring to FIG. 5, there is shown a portion of an exemplary embodiment of a watercraft rinse system 500. A fresh water source 510 is connected to a pressure booster 514 with a pressure sensor 524 being place there between. The pressure booster 514 is then connected to a splitter 526 that splits the fresh water from one line to three separate conduits. A top conduit 516, a mid-level conduit 518, and a lower conduit 520 are each connected to the splitter 526 with a valve 512 placed there between. The pressure sensor 524, the pressure booster 514, and the valve 512 of each conduit are then operably connected to a controller 508. This configuration advantageously provides the watercraft rinse system 500 with the ability to adjust its operating pressure through triggering of the pressure booster 514 by the controller 508 and with the ability to control which conduit(s) are receiving fresh water. It should be understood that while this configuration has been shown with conduits, the system may have as few as one conduit or 1+n conduits as needed for a particular watercraft.

To illustrate, for instance, when the pressure of the fresh water source 510 is lower than 30 psi, the pressure sensor 524 sends a signal to the controller 508 with the pressure value. The controller 508 may then do nothing and allow the system to operate under current conditions, may turn the pressure booster 514 on to increase the pressure to 52-75 psi, or the controller 508 may trigger—using the valve 512—one conduit at a time and allowing said conduit to remain on until a flow sensor 528 senses that a predetermined number of gallons has passed into said conduit or until a predetermined time has passed. For instance, the system may be configured to allow 4-8 gallons of water to flow into each conduit or may be configured to allow water to flow into each conduit for 1-3 minutes. The number of gallons or time elapsed are for illustrative purposes only are not to be used to restrict the amount of water or length of time that the system may operate.

Additionally, the system may be configured with sensors that detect the height of the watercraft relative to the top surface of the water thus toggling individual conduits on/off pursuant to a predetermined height requirement. The types of sensors that may be used include but are not limited to: electro-mechanical, pneumatic, magnetic, inductive, capacitive, photoelectric, and/or ultrasonic.

This triggering of the conduits may continue until all conduits in the watercraft rinse system 500 have been triggered. The controller 508 may also turn on the pressure booster 514 and trigger all conduits so that they are open and receiving fresh water.

In general, the controller 508 may have four duty cycles: standard, eco, quick, and heavy duty. The controller 508 may initiate the watercraft rinse system 500 through an input from a user, e.g, a start signal from a watercraft lift system indicating that the system is moving out of the water, depressing a button on the controller 508 panel, from an application loaded onto a mobile device, from a remote control unit—such as an infrared, radio frequency, or Bluetooth based unit, from sensors that can detect the raising of a watercraft out of a body of water, or with a timer set to periodically rinse a watercraft.

In standard operation, the watercraft rinse system 500 will ensure that operating pressure is at 52-70 psi, operate the conduits individually beginning with the top or furthest displaced from ground level conduit first and then shutting of the first before turning on the next lowest level conduit and repeating until all conduits have been triggered on/off, and ensure that each conduit level receives 4-8 gallons before shutting it off and triggering the next level.

In eco mode, the watercraft rinse system 500 uses water pressure as received from the fresh water source 510 and allows each conduit to receive fresh water for two minutes before shutting it off and triggering the next level.

In quick mode, the watercraft rinse system 500 will ensure that operating pressure is at 52-70 psi, operate all conduits together thus reducing the amount of time to rinse the watercraft.

In heavy duty mode, the watercraft rinse system 500 will ensure that operating pressure is at 52-70 psi operate the conduits individually beginning with the top or furthest displaced from ground level conduit first and then shutting of the first before turning on the next lowest level conduit and repeating until all conduits have been triggered on/off, and ensure that each conduit level receives 4-8 gallons before shutting it off and triggering the next level.

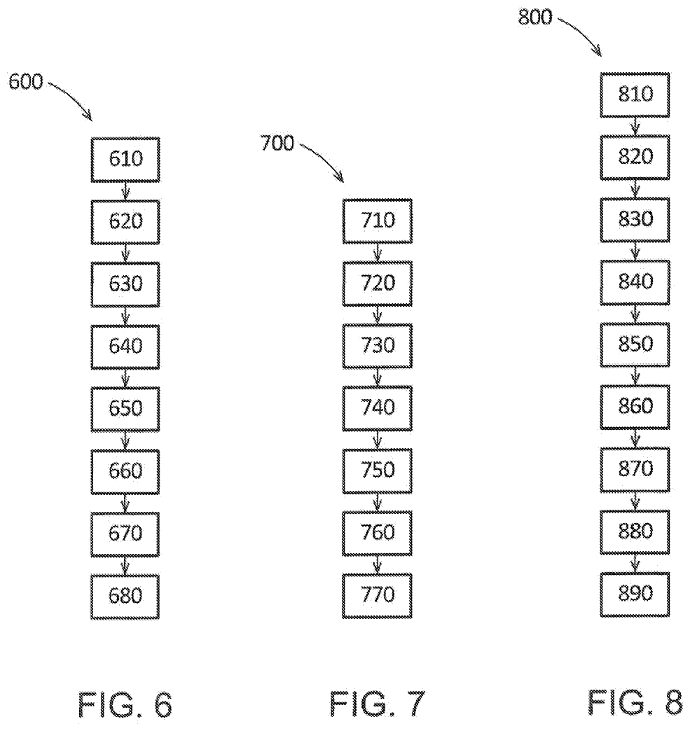

Now referring to FIG. 6, there is shown an exemplary method of using the present invention. The method 600 providing 610 a boat lift having a cradle to lift a boat out of a body of water.

Installing 620 onto the boat lift a watercraft rinse system with a plurality of conduits being arranged in a top, a mid-level, and lower formation with each conduit being supplied with a valve and a flow sensor. The watercraft rinse system further including a fresh water source, a pressure sensor, a pressure booster, a splitter to split the fresh water source into the three conduits, and a controller.

Placing 630 the boat into the cradle and activating 640 the boat lift to begin raising the boat out of the water. Initiating 650 the watercraft rinsing system with a sensor that detects the movement of the boat from the water. Triggering 660 the top conduit on and leaving on for a total of two minutes. Triggering 670 the top conduit off and then triggering the mid-level conduit on and leaving on for a total of two minutes. Triggering 680 the mid-level conduit off and then triggering the lower conduit on and leaving on for a total of two minutes.

Now referring to FIG. 7, there is shown another exemplary method of using the present invention. The method 700 providing a boat lift having a cradle to lift a boat out of a body of water.

Installing 720 onto the boat lift a watercraft rinse system with a plurality of conduits being arranged in a top, a mid-level, and lower formation with each conduit being supplied with a valve and a flow sensor. The watercraft rinse system further including a fresh water source, a pressure sensor, a pressure booster, a splitter to split the fresh water source into the three conduits, and a controller.

Providing 730 the boat on the cradle in a position fully out of the water. Initiating 740 the watercraft rinsing system with a timer set to turn on the watercraft rinsing system every seven days. Triggering 750 the top conduit on and leaving on for a total of two minutes. Triggering 760 the top conduit off and then triggering the mid-level conduit on and leaving on for a total of two minutes. Triggering 770 the mid-level conduit off and then triggering the lower conduit on and leaving on for a total of two minutes.

Now referring to FIG. 8, there is shown an exemplary method of using the present invention. The method 800 providing 810 a boat lift having a cradle to lift a boat out of a body of water.

Installing 820 onto the boat lift a watercraft rinse system with a plurality of conduits being arranged in a top, a mid-level, and lower formation with each conduit being supplied with a valve and a flow sensor. The watercraft rinse system further including a fresh water source, a pressure sensor, a pressure booster, a splitter to split the fresh water source into the three conduits, and a controller.

Placing 830 the boat into the cradle and activating 840 the boat lift to begin raising the boat out of the water. Initiating 850 the watercraft rinsing system with a sensor that detects the movement of the boat from the water. Turning 860 on the pressure booster to obtain 40-50 psi. Triggering 870 the top conduit on and leaving on until the flow sensor measures five gallons of water. Triggering 880 the top conduit off and then triggering the mid-level conduit on and leaving on until the flow sensor measures five gallons of water. Triggering 890 the mid-level conduit off and then triggering the lower conduit on and leaving on until the flow sensor measures five gallons of water.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A watercraft rinsing system, the system comprising:
a plurality of conduits being arranged in a configuration whereby a portion of the plurality of conduits forms a first layer, a second layer and a third layer, wherein each layer is arranged substantially parallel to a generally horizontal surface;
a plurality of fresh water outlets being arranged along the plurality of conduits;
a plurality of fasteners being configured for mounting the plurality of conduits to a mounting surface;
a controller being configured for operating the system; and
a water inlet being configured for connection with a water source.

2. The system of claim 1, wherein the system further includes:
a pressure booster having an inlet and an outlet, the pressure booster inlet being connected with the water inlet;
a splitter having an inlet and a plurality of outlets, the splitter inlet being connected with the outlet from the pressure booster, and
a plurality of valves each having an inlet and an outlet, wherein at least one valve inlets being connected at least one of the splitter outlets.

3. The system of claim 2, wherein each splitter outlet includes a dedicated flow sensor.

4. The system of claim 3, wherein the controller is operably connected to each of the dedicated flow sensors, wherein the controller is configured to shut off the flow of water to any conduit once said conduit has received five gallons of water.

5. The system of claim 1, wherein the controller is operably connected to a sensor being configured to detect a movement.

6. The system of claim 2, wherein the pressure booster is operably connected to a pressure sensor being configured to detect a pressure of the water source.

7. The system of claim 6, wherein the pressure booster is being configured to turn on when the water source pressure is below 30 psi.

8. The system of claim 7, wherein the pressure booster deactivates when the water source pressure is above 72 psi.

9. A method for rinsing a watercraft, the method comprising:
providing a watercraft lift having a cradle to lift a watercraft out of a body of water;
installing onto the boat lift a watercraft rinse system having a plurality of conduits being arranged in a top, a mid-level, and lower formation, a fresh water source, a pressure sensor, a pressure booster, a splitter to split the fresh water source into the three conduits, and a controller, wherein each conduit includes a valve;
placing the watercraft into the cradle;
activating the watercraft lift to begin raising the watercraft out of the water;
triggering the top conduit on;
triggering the top conduit off and then triggering the mid-level conduit on; and
triggering the mid-level conduit off and then triggering the lower conduit on.

10. The method of claim 9, wherein the top conduit, the mid-level conduit, and lower conduit are each on for a total of two minutes before turning off.

11. The method of claim 9, wherein each conduit includes a flow sensor.

12. The method of claim 11, wherein the top conduit, the mid level conduit, and lower conduit are each on until three to five gallons has passed through the flow sensor.

13. The method of claim 9, wherein the method for watercraft rinsing system with a sensor that detects the movement of the watercraft relative to the water.

14. The method of claim 9, wherein the method further includes initiating the watercraft rinsing system with a time being configured to turn on the watercraft rinsing system every seven days.
